(19) United States
(12) Patent Application Publication
(10) Pub. No.: US 2003/0145589 A1
(43) Pub. Date: Aug. 7, 2003

(54) Fluid displacement method and apparatus

(76) Inventor: Joseph P. Tillyer, Sparta, NJ (US)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/320,102

(22) Filed: Dec. 16, 2002

Related U.S. Application Data
(60) Provisional application No. 60/341,653, filed on Dec. 17, 2001.

(51) Int. Cl. F03C 1/00

(52) U.S. Cl. 60/496; 60/495

(57) ABSTRACT

A method and apparatus for using, converting and/or generating energy comprises disposing a second fluid adjacent at least one receiver and allowing the at least one receiver to rise with respect to a first fluid, the at least one receiver being connected to an output member. The apparatus includes at least one receiver disposed within the first fluid, a second fluid, and an output member connected to the at least one receiver.

### CROSS-REFERENCE TO RELATED APPLICATIONS

This application claims benefit of U.S. Provisional Application Serial No. 60/341,653, filed Dec. 17, 2001, the disclosure of which is hereby incorporated by reference herein.

### FIELD OF THE INVENTION

This invention relates to a methods and apparatus for power systems including systems for using, generating and/or converting power.

### BACKGROUND OF THE INVENTION

Demand for power varies during different periods of time or during the course of an operation. For example, the demand for electrical power varies dramatically during the course of the day, as businesses and residences use more power in the late morning and afternoon. The longest portion of the daily demand for power is supplied by facilities that have low operating costs over time, but generate surplus power during off-peak periods, which last only a few hours.

The surplus power can be used to supplement main power systems during peak hours or periods. Pumped storage facilities use stored power in the form of elevated storage tanks, taking advantage of the potential energy of an elevated location. Surplus power generated during off-peak hours is used to pump water into an elevated storage tank. The low-cost surplus power is stored and available for use during peak periods. The stored energy is used for driving the electrical power plant during the peak hours. The efficiency of electrical power plants is improved through the use of the stored power. However, construction of pumped storage facilities is expensive and disrupts large areas of land. In addition, a site having adequate space for the storage tanks is required. Pumped storage facilities can require hundreds of acres of land. A portion of the facility must be located at an elevation, which may be a thousand feet above sea level.

Another type of facility is the gas turbine. However, the operating costs of the gas turbine vary with the cost of fuel.

Another facility is the compressed air storage facility. During off-peak times, air is compressed and pumped underground to pressures up to 1,000 lbs. per square inch or more. The compressed air is released and heated using a small amount of natural gas, and flows through a turbine generator for producing electricity. These facilities operate between pressures of 600-1,600 lbs. per square inch for the compressed air. Certain facilities utilize underground mines for storing the compressed air, which require that these mines are arranged and structured to hold the compressed air. Doubts concerning the ability of mines to hold the compressed air have stalled the development of such facilities.

Further improvements in methods and apparatus for using, converting and/or generating power are desired.

### SUMMARY OF THE INVENTION

In one aspect of the present invention, a fluid displacement machine comprises a first fluid, at least one output member, and at least one receiver disposed in the first fluid and connected to the at least one output member. The machine further comprises a fluid outlet arranged to dispose a second fluid adjacent a lower surface of the at least one receiver. The first fluid has a density greater than a density of the second fluid. The second fluid displaces the first fluid from adjacent the at least one receiver, so that the at least one receiver rises, applying energy to the at least one output member.

The fluid displacement machine makes use of the tendency of a fluid having a lower density to rise within a fluid having a greater density. The rising fluid moves a receiver attached to an output member for using, converting and/or generating energy. The second fluid may comprise a fluid stored during off-peak hours, or any other natural or otherwise generated source of fluid. The first fluid may comprise any fluid that has a density greater than the second fluid. The fluid displacement machine may be used in any system for using, converting and/or generating energy.

In certain embodiments, the first fluid comprises water and the second fluid comprises a gas. The gas may comprise compressed air. The compressed air may have a source, such as a natural mine or tank for holding the compressed air. The source may comprise a compressor, which is used in certain embodiments of the invention to compress air. In other embodiments, other sources of fluids are used and the first fluid and second fluid may comprise any fluid.

The at least one receiver desirably comprises at least one container having an open end. The machine may include a conveyor assembly for connecting the at least one receiver or at least one container to the at least one output member. The conveyor assembly may be arranged in a loop and supported within a tank of the first fluid so that the conveyor assembly is connected to the output member. The at least one receiver is connected to the conveyor assembly for applying energy to the output member. The output member may comprise at least one shaft that is rotated by the conveyor assembly.

The conveyor assembly desirably includes a plurality of wheels. At least one of the wheels may be connected to the at least one output member. The conveyor assembly may comprise a belt disposed in a loop around the plurality of wheels, with the at least one receiver comprising at least one container connected to the belt.

In certain embodiments, the at least one container comprises a plurality of containers having an open end and connected to the belt of the conveyor assembly so that containers on a first side of the conveyor assembly are arranged with the open ends facing downwardly and the containers on the second side are arranged with the open ends facing upwardly. The conveyor assembly may be arranged so that the containers on the first side are disposed over the fluid outlet for receiving second fluid from the fluid outlet. A lower container may be arranged on the belt so as to receive second fluid from the fluid outlet. An upper container may be arranged on the belt so as to release the second fluid from the upper container.

The at least one container desirably has an inner side adjacent the belt and an outer side opposite the inner side. In certain embodiments, the outer side of the at least one container defines a notch.

In certain embodiments, the at least one output member is connected to a generator. Thus, the present invention contemplates the generation of electrical energy and any other form of energy, as well as other uses.

The fluid outlet may be connected to a source of the second fluid. The source of the second fluid may comprise a natural reservoir of the second fluid. The source may also comprise a compressor. In certain embodiments, compressed air is stored in a natural mine or aquifer, or other reservoir.

In a further aspect of the present invention, a method of converting energy comprises providing a receiver disposed in a first fluid and disposing a second fluid adjacent a lower surface of the receiver. The second fluid has a density less than a density of the first fluid. The method includes allowing the receiver, which is connected to at least one output member, to rise within the first fluid and the receiver. In certain embodiments, the second fluid is release from a fluid outlet, which may be disposed within a tank of first fluid. The step of allowing the receiver to rise may include applying energy to the at least one output member from the rising receiver. Energy may be applied to the at least one output member by moving a conveyor assembly connected to the at least one output member and the at least one receiver.

The step of applying energy to the at least one output member may comprise applying energy to a shaft connected to a generator. The method may further include generating electrical energy utilizing the generator. In other embodiments, other forms of energy are generated, or the method is used for other purposes.

Methods according to embodiments of the present invention may also include supplying second fluid from a source. Supplying the second fluid may include compressing the second fluid. The second fluid may be supplied by releasing the second fluid from a natural reservoir of second fluid. The source may comprise a tank, reservoir, mine, or any other source of fluid. The method may also include storing second fluid in a source.

The step of introducing the second fluid may include allowing the second fluid to rise within the first fluid to the at least one receiver. The receiver may comprise a plurality of receivers. In certain embodiments, the receivers rise, moving a lower receiver into a position for receiving second fluid. The second fluid may rise from a fluid outlet into a receiver comprising a lower container. The lower container rises within the tank, moving a successive container into a position over the fluid outlet.

The step of storing second fluid may be carried out during a period of decreased demand for energy and the step of releasing second fluid may be carried out during a period of increased demand for energy. In other embodiments, these steps are carried out at any time.

### BRIEF DESCRIPTION OF THE DRAWINGS

These and other features, aspects, and advantages of the present invention will become better understood with regard to the following description, appended claims and accompanying drawings where:

FIG. 1 is a cross-sectional view of a fluid displacement machine in accordance with an embodiment of the present invention;

FIG. 2 is a top plan view of a power system having the fluid displacement machine in accordance with the embodiment of FIG. 1;

FIG. 3 is a schematic top plan view of a container for the fluid displacement machine in accordance with the embodiment of FIGS. 1 and 2;

FIG. 4 is a top plan view of a power system having a fluid displacement machine in accordance with a further embodiment of the invention;

FIG. 5 is a cross-sectional view of a fluid displacement machine in accordance with a further embodiment of the invention; and

FIG. 6 is a top plan view of a fluid displacement machine in accordance with the embodiment of FIG. 5.

### DETAILED DESCRIPTION

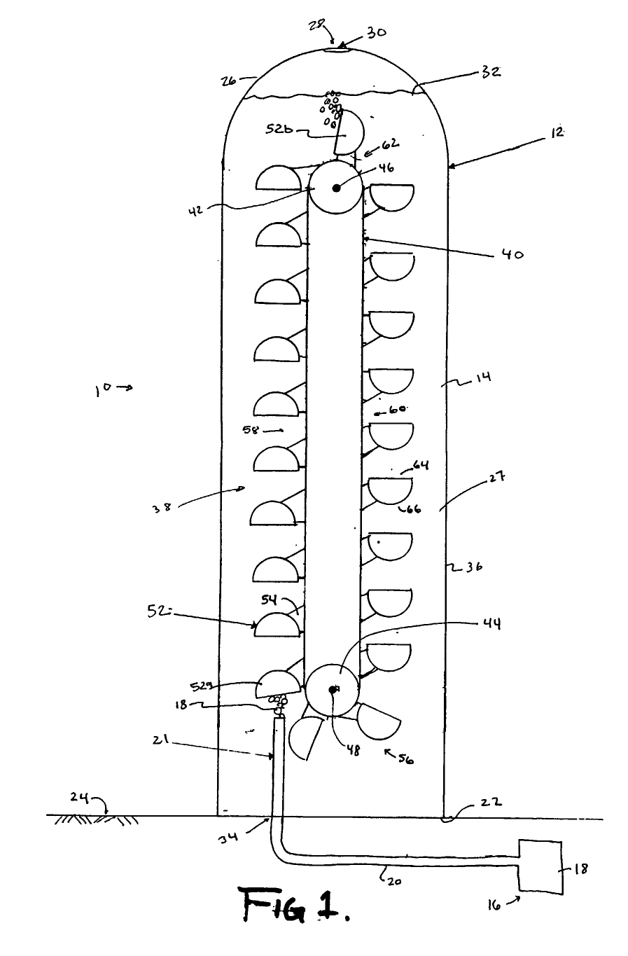

FIGS. 1-3 show an embodiment of the present invention, in which a fluid displacement machine 10 has a tank 12 containing a first fluid 14. None of the figures are drawn to scale and the figures are schematic. The fluid displacement machine 10 is connected to a source 16 of a second fluid 18 by a conduit 20. The density of the first fluid 14 is greater than the density of the second fluid 18.

The tank 12 of the fluid displacement machine 10 comprises any tank for containing the first fluid 14. In the embodiment shown, the tank 12 comprises an elongated tank having a flat bottom wall 22 for being supported on the ground or another surface 24 and a top wall 26 opposite the bottom wall 22. The side of the tank 12 comprises a side wall 36 extending from the bottom wall 22 to the top wall 26 and is integral with the top wall 26 to define an interior 27. The tank 12 shown in FIG. 1 is generally cylindrical. However, the tank 12 may have any shape. In the embodiment shown, the top wall 26 is curved, having an apex 28 and a vent 30 located at the apex 28. The vent 30 may comprise a passage to a reservoir, external atmosphere, a valve, such as a release valve, or any other component. The first fluid is disposed in the tank 12, filling the tank up to a fluid level 32, desirably located adjacent the apex 28 and vent 30. The tank has an opening 34 adjacent the bottom wall 22, through which the conduit 20 enters the tank 12. The opening 34 is desirably located in the side wall 36 of the tank 12 or the bottom wall 22 and includes appropriate seals for preventing the leakage of the first fluid 14 from the tank 12 through the opening 34. The interior 27 of the tank 12 is accessible to an outlet 21 of the conduit 20. The portion of the conduit 20 disposed within the tank is designed taking into account the pressure from the first fluid and adequate flow of second fluid from the outlet 21.

The fluid displacement machine 10 includes a conveyor assembly 38 mounted within the tank 12. The conveyor assembly 38 includes a belt 40, which comprises any flexible band or chain of a material appropriate for submersion within the first fluid 14. The belt 40 is elongated and wrapped around a first wheel 42 and a second wheel 44 in a loop. The first wheel 42 is located adjacent the top wall 26 of the tank 12, beneath the fluid level 32. The second wheel 44 is located adjacent the bottom wall 22, allowing for the conduit 20 disposed within the tank 12 adjacent the bottom wall 22. Each wheel has engagement surfaces for engaging a portion of the belt so that movement of the belt will drive rotation of the wheels. For example, the belt 40 may include holes or teeth for receiving corresponding teeth on the wheels. Any other means for engaging the belt 40 with the wheels may also be used. The size of the wheels is desirably selected so as to maximize the output of the fluid displacement machine 10.

Each of the wheels includes a hole receiving a shaft. The upper wheel 42 receives an upper shaft 46 and the lower wheel 44 receives a lower shaft 48. The upper shaft 46 and lower shaft 48 mount the upper wheel 42 and the lower wheel 44, together with the belt 40, within the tank 12 and are connected either to the side wall 36 of the tank 12, or to a supporting structure located within or outside of the tank 12.

Either the upper shaft 46, the lower shaft 48, or both, comprise a drive shaft for the fluid displacement machine 10. In the embodiment shown, the lower shaft 48 comprises the drive shaft. However, the fluid displacement machine may have one or more drive shafts. The lower shaft 48 is secured to the second wheel 44 so that rotation of the belt 40 rotates the wheel 44, rotating the drive shaft. On the other hand, the upper shaft 46 remains stationary and the first wheel 42 may be connected to the upper shaft 46 in a manner that allows rotation of the wheel while the shaft remains stationary, either through the use of bearings, or other connections. In the embodiment shown, the upper shaft 46 is stationary whereas the lower shaft 48 is rotated by the lower wheel 44. The lower shaft 48 exits the tank 12 at an opening 51 in the tank. Appropriate seals are utilized to prevent the first fluid 14 from leaking from the tank 12 through the opening 51.

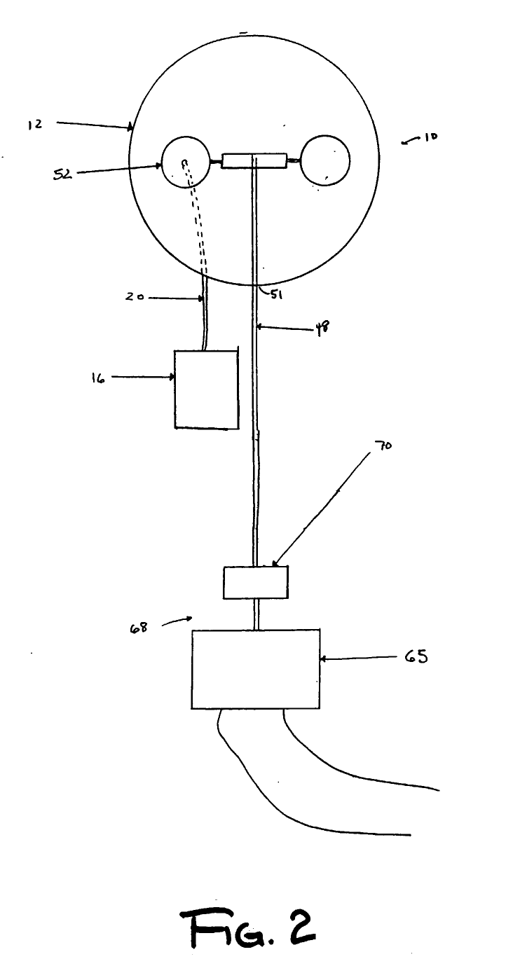

The conveyor assembly 38 desirably has an elongated configuration and is arranged in a vertical direction, as shown in FIG. 2. The conveyor assembly 38 has a lower end 56 adjacent the bottom wall 22 of the tank 12, an upper end 62 adjacent the top wall 26 of the tank 12, a left side 58 and a right side 60. The belt 40 extends from the lower end 56 of the conveyor assembly 38 from the lower wheel 44 on the left side 58 to the upper wheel 42, around the upper wheel 42 down the right side 60 to the lower end 56 in a loop.

The belt 40 carries a plurality of containers 52 connected to the belt 40 by a plurality of supports 54. The containers 52 are desirably arranged at spaced intervals along the belt 40. The size of the connection between the supports 54 and the belt 40 is arranged so that the belt 40 can pass over the wheels efficiently. The containers 52 have an open end 64 and a closed end 66 opposite the open end 64. The containers 52 are orientated on the belt 40 so that the containers 52 on the left side 58 have the open ends 64 facing downwardly. The conveyor assembly 38 is arranged with the outlet 21 of the conduit 20 so that the containers 52 on the left side 58 are disposed over the outlet 21 of the conduit. The conveyor assembly 38 is arranged so that a lower container 52a adjacent the lower end 56 is disposed adjacent the outlet 21 of the conduit 20. The containers 52 on the right side 60 have the open ends 64 facing upwardly. Desirably, the fluid level 32 and the dimensions of the tank 12 are arranged so that an upper container 52b is submerged in the first fluid 14. Desirably, the materials for each part of the conveyor assembly 38 comprise the lightest suitable materials and the connections are as frictionless as possible.

In the embodiment shown, the containers 52 on the left side 58 are disposed above the outlet 21 and the containers' open ends 64 face downwardly. However, it should be apparent that the containers 52 on the right side 60 could be disposed over the outlet 21, with the containers on the right side having open ends 64 facing downwardly, in other embodiments.

A bubbler may be disposed over the outlet 21 to collect the second fluid into larger bubbles and maximize the second fluid caught in the containers. In other embodiments, the source 16 is switched on and off, or the outlet is opened and closed, so that second fluid is only emitted when a container 52 is in position for receiving second fluid from the outlet. In other embodiments, the conduit is formed from a flexible material and is moved as the container at the lower end of the conveyor assembly moves into position over the open end. In other embodiments, the open end is spaced from the conveyor assembly so as to avoid interfering with the movement of the containers.

In a preferred embodiment, the second fluid 18 comprises compressed air and the first fluid 14 comprises water. In operation, compressed air is permitted to flow from the source 16 out the outlet 21 of the conduit 20 filling the lower container 52a located above the outlet 21. The compressed air 18 displaces a volume of water 14 from the container 52a. As the compressed air 18 is lighter than the water 14, the container 52a begins to rise within the tank 12, moving the belt in a clockwise direction around the upper wheel 42 and lower wheel 44. As the belt 40 rotates, a further container is moved into position over the outlet 21 and receives a volume of compressed air and providing further lift for the belt 40. Each container receives a volume of compressed air in this manner, rotating the belt 40. As the containers 52 rotate, the containers 52 located on the left side 58 of the conveyor assembly 38 have their open end 64 facing downwardly and, when located on the right side 60, the containers 52 have the open ends 64 facing upwardly.

In certain embodiments, the system is “primed” by initially filling one or more containers with compressed air. For example, the belt may be turned manually, by a motor, or by other means, to fill the container or containers with compressed air. Then, the fluid displacement machine is permitted to operate utilizing the compressed air to rotate the conveyor assembly.

As the belt 40 rotates, the drive shaft 50 rotates and can be used to drive the rotor of an electrical generator, another type of generator, or other device. When a container 52 reaches the upper end 62 of the conveyor assembly 38, the belt 40 pulls the container around the upper wheel 42, releasing the compressed air. The compressed air bubbles up to the fluid level 32 and eventually out the vent 30 at the top wall 26 of the tank 12.

The source 16 comprises any source of fluid, including liquids, gasses and compressed gasses. The source 16 desirably comprises a storage reservoir of compressed air or other fluid, including an elevated water tank, a tank of stored compressed gas, an underground aquifer or reservoir of liquid or gaseous fluids. Among other uses, the fluid displacement machine may be used for generating, converting and/or using energy from an auxiliary power source. For example, a source of compressed air is disclosed in U.S. Pat. No. 3,523,192 to Lang, the disclosure of which is hereby incorporated by reference herein.

The lower shaft 48 is connected to any mechanical, hydraulic, or other system for using, converting or generating energy. In the embodiment shown in FIG. 2, the lower shaft 48 is connected to an electrical generator 65. As discussed above, the conveyor assembly 38 rotates the lower shaft 48 and the lower shaft 48 is connected to a generator 65 for generating electrical energy. The lower shaft 48 is connected to a gear box 70 that is in turn connected to a shaft 68 for driving the generator 65. Shaft 68 may be directly or indirectly connected to the generator 65 or other system by any appropriate means. Preferably, the connections and the gears are as frictionless as possible, and the gears are selected and arranged to increase or decrease the speed of rotation for the generator, or to otherwise adapt the output of the fluid displacement machine.

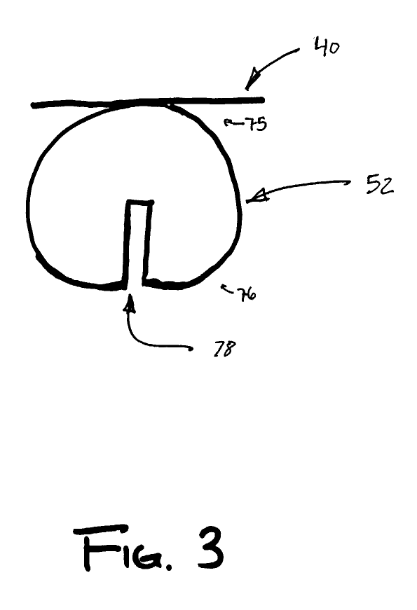

The containers 52 are preferably shaped to reduce the drag on the containers 52 from the first fluid 14 and the supports 54 are also preferably designed to reduce drag. The containers 52 may comprise containers 52 having a circular shape in plan and a semicircular shape in elevation, as seen in FIGS. 1 and 3, but may have any other shape. The containers 52 have an inner side 75 adjacent the belt 40 and an outer side 76 opposite the inner side 75. In certain embodiments, the outlet 21 of the conduit 20 is spaced as closely as possible to the containers at the lower end 56 of the conveyor assembly 38 to maximize the amount of second fluid caught by the containers 52 and to minimize loss of the second fluid 18 into the tank 12. In certain embodiments, the containers 52 each have a notch 78 for accommodating the outlet 21 of the conduit 20 as the containers 52 move from the lower end 56 of the conveyor assembly 38 into position over the outlet 21. This minimizes the air loss as containers 52 move away from the outlet 21 and a successive container moves into position over the outlet 21. In other embodiments, the conduit 20 comprises a flexible tube that is engaged by the containers and moved out of the way as the containers rise. Preferably, the shape of the containers reflects a compromise between maximizing the compressed air caught in each container and minimizing the drag on each container from the first fluid.

The fluid displacement machine 10 is desirably comprised of materials appropriate to the fluids used and the surrounding environment. For example, where water comprises the first fluid 14, the tank 12 and the structure within the tank 12 should resist corrosion due to the exposure to water. In addition, the structures should be designed with fluid pressures in mind. Steel, other metals, plastics and other materials may be used.

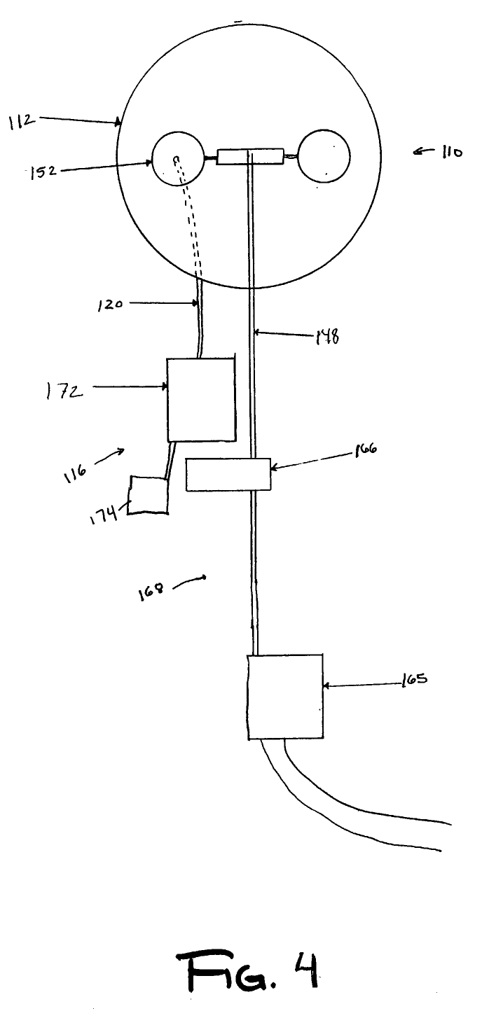

In embodiments in which the second fluid comprises compressed air, the compressed air may be generated during off-peak hours, or at any convenient time. In certain embodiments, the source 116 includes an air compressor 172 that is connected to a motor 174 as shown in FIG. 4. In generating compressed air, the motor 174 is utilized to run the compressor 172. The compressed air may be stored in source 116, or used at any time.

In other embodiments, the fluid displacement machine comprises a plurality of conduits having outlets disposed adjacent each container on one side of the conveyor assembly. The conduits may be inclined so as to project second fluid toward containers from a side of the conveyor assembly. The fluid displacement machine may comprise one or more sources of second fluid associated with the conduits. Preferably, the conveyor assembly and fluid displacement machine are arranged to limit loss of second fluid into the interior of the tank and to maximize the second fluid captured by the containers.

Numerous variations on the present method and apparatus are contemplated by the present invention. For example, the energy generated by the fluid displacement machine can be used to run a turbine, pump, motor, generator, or any other machine or system. In addition, the size and shape of the tank can be varied. The conveyor assembly 38 shown in FIG. 1 is elongated in a vertical direction. However, the conveyor assembly may have other shapes, such as a conveyor assembly elongated in an inclined direction or a horizontal direction. Although the containers shown in FIG. 3 have a generally circular shape, other shapes may be used. Furthermore, the containers on the conveyor assembly may not all have the same shape or size. The size and shape of the containers may vary.

Methods and apparatus according to the present invention include a fluid displacement machine used with any sources of energy. For example, an elevated reserve water tank may be utilized to compress air or other gas to be used in a fluid displacement machine, such as the machine shown in FIG. 1. Water from such energy sources may be utilized as the second fluid 18 for turning conveyor assembly, such as the conveyor assembly 38 shown in FIG. 1. In such embodiments, the conveyor assembly may be elongated in a horizontal direction and the drive shaft may be connected to a generator 65 or other machine.

The first fluid and second fluid may comprise any fluids, with the first fluid having a greater density than the second fluid. The fluids may comprise liquids or gases, such as water, seawater, oil, gasoline, mercury, air, carbon dioxide, nitrogen, helium, or any others.

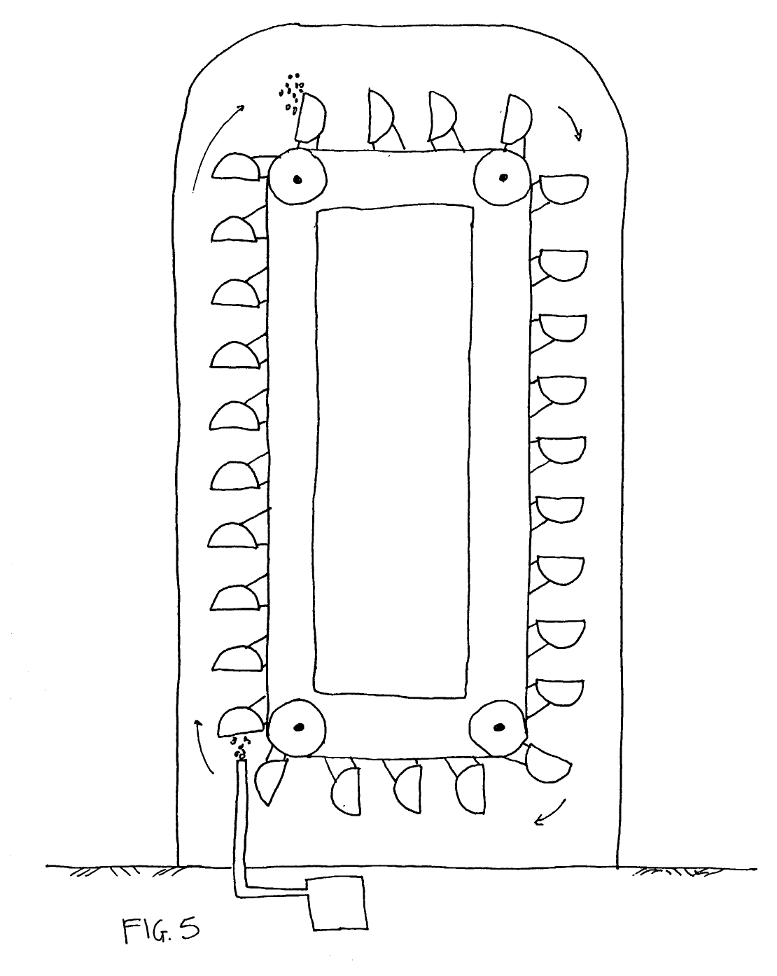

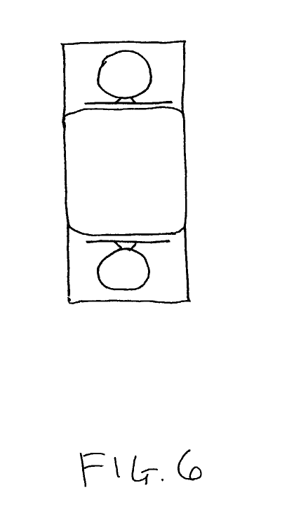

Circulation of the first fluid within the tank may be utilized in certain embodiments to aid in rotating the containers. The first fluid may comprise flowing water from a source of first fluid or the shape of the tank may be selected to help circulate the first fluid within the tank. The tank may be shaped to accommodate or encourage flow of the first fluid. For example, an embodiment of a tank is shown in FIGS. 5 and 6. The tank forms a conduit shaped so that the first fluid flows around in a continuous path, in the same direction as the conveyor assembly.

### EXAMPLES

In the following examples, the second fluid pressure, the depth of the tank, the radius of the containers and the number of containers in the machine were selected. For each example, the following values were used: the acceleration due to gravity is 9.8 m/s²; a density for air of 1.29 kg/m³; and the density of water is 1,000 kg/m³. In each of the examples, a total of 20 containers were used and the spacing of the containers on the conveyor was 10 meters. In each example, the depth of the tank was 100 meters.

The following calculations calculate the speed of second fluid rising in the tank based on the size of a bubble of second fluid, with each container catching a bubble of second fluid. The following equation was used: u equals ⅔ times the square root of g/R; where u is the upward speed of the bubble, g is the acceleration due to gravity, and R is the radius of the bubble. The radius of the bubble is assumed to be the same as the radius of the containers. In each example, the second fluid was compressed air and the first fluid was water.

As appreciated from the examples below, methods and apparatus according to embodiments of the present invention generate a significant amount of power and utilize compressed air at pressures lower than the 600-1,600 psi used in compressed air facilities using turbines.

| First example | | |
|---|---|---|
| Pressure in tank | 100 | psi |
| Radius of container | 5 | m |
| Volume of air in container | 9,245.36 | ft³ |
| when full | | |
| Pressure of air at the top of | 100.00 | psi |
| tank | | |
| Pressure of air at the bottom | 242.07 | psi |
| of tank | | |
| Mass of air in container at | 744.54 | lb |
| 14.7 psi | | |
| Mass of air in container at | 5,064.90 | lb |
| bottom of tank | | |
| Volume of air at the bottom | 3,818.23 | ft³ |
| of tank | | |
| Mass of water displaced at | 238,362.15 | lb |
| the bottom of the tank | | |
| Mass of water displaced at | 577,162.93 | lb |
| top of tank | | |
| Mean mass of water displaced | 407,762.54 | lb |
| Buoyant force | 4,067,444.63 | lb |
| Speed of containers | 3.06 | ft/s |
| Power | 22,627.91 | HP |
| Second example | | |
| Pressure in tank | 400 | psi |
| Radius of container | 5 | m |
| Volume of air in container | 9,245.36 | ft³ |
| when full | | |
| Pressure of air at the top of | 400.00 | psi |
| tank | | |
| Pressure of air at the bottom | 542.00 | psi |
| of tank | | |
| Mass of air in container at | 744.54 | lb |
| 14.7 psi | | |
| Mass of air in container at | 20,259.60 | lb |
| bottom of tank | | |
| Volume of air at the bottom | 6,821.42 | ft³ |
| of tank | | |
| Mass of water displaced at | 425,842.87 | lb |
| the bottom of the tank | | |
| Mass of water displaced at | 577,162.93 | lb |
| top of tank | | |
| Mean mass of water displaced | 501,502.90 | lb |
| Buoyant force | 5,004,218.26 | lb |
| Speed of containers | 3.06 | ft/s |
| Power | 27,839.34 | HP |
| Third example | | |
| Pressure in tank | 14.7 | psi |
| Radius of container | 5 | m |
| Volume of air in container | 9,245.36 | ft³ |
| when full | | |
| Pressure at the top of tank | 14.7 | psi |
| Pressure at the bottom of | 156.80 | psi |
| tank | | |
| Mass of air in container at | 744.54 | lb |
| 14.7 psi | | |
| Mass of air in container at | 744.54 | lb |
| bottom of tank | | |
| Volume of air at the bottom | 866.55 | ft³ |
| of tank | | |
| Mass of water displaced at | 54,096.26 | lb |
| the bottom of the tank | | |
| Mass of water displaced at | 577,162.93 | lb |
| top of tank | | |
| Mean mass of water displaced | 315,629.60 | lb |
| Buoyant force | 3,146,734.38 | lb |
| Speed of containers | 3.06 | ft/s |
| Power | 17,505.83 | HP |
| Fourth example | | |
| Pressure in tank | 100 | psi |
| Radius of container | 10 | m |
| Volume of air in container | 73,962.87 | ft³ |
| when full | | |
| Pressure at the top of tank | 100.00 | psi |
| Pressure at the bottom of | 242.07 | psi |
| tank | | |
| Mass of air in container at | 5,956.32 | lb |
| 14.7 psi | | |
| Mass of air in container at | 40,519.19 | lb |
| bottom of tank | | |
| Volume of air at the bottom | 30,545.88 | ft³ |
| of tank | | |
| Mass of water displaced at | 1,906,897.19 | lb |
| the bottom of the tank | | |
| Mass of water displaced at | 4,617,303.44 | lb |
| top of tank | | |
| Mean mass of water displaced | 3,262,100.32 | lb |
| Buoyant force | 32,539,557.06 | lb |
| Speed of containers | 2.17 | ft/s |
| Power | 128,002.77 | HP |
| Fifth example | | |
| Pressure in tank | 100 | psi |
| Radius of container | 1 | m |
| Volume of air in container | 73.96 | ft³ |
| when full | | |
| Pressure at the top of tank | 100.00 | psi |
| Pressure at the bottom of | 242.07 | psi |
| tank | | |
| Mass of air in container at | 5.96 | lb |
| 14.7 psi | | |
| Mass of air in container at | 40.52 | lb |
| bottom of tank | | |
| Volume of air at the bottom | 30.55 | ft³ |
| of tank | | |
| Mass of water displaced at | 1,906.9 | lb |
| the bottom of the tank | | |
| Mass of water displaced at | 4,617.3 | lb |
| top of tank | | |
| Mean mass of water displaced | 3,262.1 | lb |
| Buoyant force | 32,539.56 | lb |
| Speed of containers | 6.85 | ft/s |
| Power | 404.78 | HP |
| Sixth example | | |
| Pressure in tank | 14.7 | psi |
| Radius of container | 1 | m |
| Volume of air in container | 73.96 | ft³ |
| when full | | |
| Pressure at the top of tank | 14.7 | psi |
| Pressure at the bottom of | 156.8 | psi |
| tank | | |
| Mass of air in container at | 5.96 | lb |
| 14.7 psi | | |
| Mass of air in container at | 5.96 | lb |
| bottom of tank | | |
| Volume of air at the bottom | 6.93 | ft³ |
| of tank | | |
| Mass of water displaced at | 432.77 | lb |
| the bottom of the tank | | |
| Mass of water displaced at | 4,617.3 | lb |
| top of tank | | |
| Mean mass of water displaced | 2,525.04 | lb |
| Buoyant force | 25,173.88 | lb |
| Speed of containers | 6.85 | ft/s |
| Power | 313.15 | HP |

The examples discussed above do not calculate the drag (fluid resistance) on the containers or conveyor assembly or the weight of the containers or conveyor assembly. However, the shape of the containers and conveyor assembly can be designed to minimize drag. In addition, extremely light materials can be used, such as composite materials including polymers and carbon fibers or other fibers, and any other light-weight materials.

Although the invention herein has been described with reference to particular embodiments, it is to be understood that these embodiments are merely illustrative of the principles and applications of the present invention. For example, a wide variety of fluids may be used in embodiments according to the present invention. In addition, the size of the tank and containers may be varied and apparatus according to the present invention may be utilized for using, converting and/or generating energy for use in a variety of applications. In addition, the source of the second fluid may comprise auxiliary or temporary sources of stored power, or may comprise naturally existing sources of compressed air or other fluids. Any source of first and second fluid may be used. The first and/or second fluid may comprise a natural body of fluid. The tank, for example, may be eliminated in certain embodiments. It is therefore to be understood that numerous modifications may be made to the illustrative embodiments and that other arrangements may be devised without departing from the spirit and scope of the present invention as defined by the appended claims.

1. A fluid displacement machine, comprising a first fluid, at least one output member, at least one receiver disposed in the first fluid and connected to the at least one output member, and a fluid outlet arranged to dispose a second fluid adjacent a lower surface of the at least one receiver, the second fluid displacing the first fluid from adjacent the at least one receiver and the first fluid having a density greater than a density of the second fluid so that the at least one receiver rises, applying energy to the at least one output member.

2. The machine of claim 1, wherein the first fluid comprises water and the second fluid comprises a gas.

3. The machine of claim 2, wherein the gas comprises compressed air.

4. The machine of claim 1, wherein the at least one receiver comprises at least one container having an open end.

5. The machine of claim 1, further comprising a conveyor assembly for connecting the at least one receiver to the at least one output member.

6. The machine of claim 5, wherein the conveyor assembly is arranged in a loop and supported within a tank of the first fluid so that the conveyor assembly is connected to the output member and the at least one receiver is connected to the conveyor assembly for applying energy to the output member.

7. The machine of claim 6, wherein the at least one output member comprises at least one shaft that is rotated by the conveyor assembly.

8. The machine of claim 5, wherein the conveyor assembly includes a plurality of wheels.

9. The machine of claim 8, wherein at least one of the wheels are connected to the at least one output member.

10. The machine of claim 9, wherein the conveyor assembly further comprises a belt disposed in a loop around the plurality of wheels, the at least one receiver comprising at least one container connected to the belt.

11. The machine of claim 10, wherein the at least one container comprises a plurality of containers having an open end, the conveyor assembly having a first side and a second side, the containers being connected to the belt so that the containers on the first side are arranged with the open ends facing downwardly and the containers on the second side are arranged with the open ends facing upwardly.

12. The machine of claim 11, wherein the conveyor assembly is arranged so that the containers on the first side are disposed over the fluid outlet for receiving second fluid from the fluid outlet.

13. The machine of claim 11, wherein a lower container is arranged on the belt so as to receive second fluid from the fluid outlet and an upper container is arranged on the belt so as to release the second fluid from the upper container.

14. The machine of claim 4, wherein the at least one container has an inner side adjacent the belt and an outer side opposite the inner side, the outer side defining a notch.

15. The machine of claim 1, wherein the at least one output member is connected to a generator.

16. The machine of claim 15, wherein the fluid outlet is connected to a source of the second fluid.

17. The machine of claim 16, wherein the source of the second fluid comprises a natural reservoir of the second fluid.

18. The machine of claim 16, wherein the source comprises a compressor.

19. A method of converting energy, comprising providing a receiver disposed in a first fluid, disposing adjacent a lower surface of the receiver a second fluid having a density less than a density of the first fluid, and allowing the receiver to rise within the first fluid, the receiver being connected to at least one output member.

20. The method of claim 19, wherein the step of introducing a second fluid includes releasing the second fluid from a fluid outlet.

21. The method of claim 20, wherein the step of releasing comprises releasing the second fluid from a fluid outlet disposed within a tank of first fluid.

22. The method of claim 19, wherein the step of allowing the receiver to rise includes applying energy to the at least one output member from the rising receiver.

23. The method of claim 22, wherein the step of applying includes moving a conveyor assembly connected to the at least one output member and at least one receiver.

24. The method of claim 19, wherein the step of applying energy to the at least one output member comprises applying energy to a shaft connected to a generator.

25. The method of claim 24, further comprising generating electrical energy utilizing the generator.

26. The method of claim 19, further comprising supplying the second fluid.

27. The method of claim 26, wherein the step of supplying includes releasing the second fluid from a natural reservoir of second fluid.

28. The method of claim 26, wherein the supplying includes compressing the second fluid.

29. The method of claim 19, further comprising storing second fluid in a source.

30. The method of claim 19, wherein the step of introducing includes allowing the second fluid to rise within the first fluid to the at least one receiver.

31. The method of claim 30, wherein the at least one receiver comprises a plurality of receivers and wherein the step of allowing the receivers to rise includes moving a lower receiver into a position for receiving second fluid.

32. The method of claim 30, wherein the second fluid rises from the fluid outlet into a receiver comprising a lower container, so that the lower container rises within the tank, moving a successive container into a position over the fluid outlet.

33. The method of claim 29, wherein the step of storing second fluid is carried out during a period of decreased demand for energy and the step of releasing second fluid is carried out during a period of increased demand for energy.

34. A method of generating power, comprising:
a) compressing a first compressible fluid during a first period of time; and
b) disposing the first fluid adjacent a lower surface of a receiver, the receiver being disposed in a second fluid having a greater density than a density of the first fluid, so that the receiver rises within the second fluid so that a generator connected to the receiver generates power during a second period of time;
c) the demand for power during the first period of time being less than the demand for power during the second period of time.

35. The method of claim 34, further comprising storing the compressed first fluid in a source before the step of disposing.

36. The method of claim 34, wherein the step of disposing the first fluid adjacent the receiver includes disposing the first fluid adjacent a first receiver so that the first receiver rises, moving a second receiver into a predetermined position for receiving the first fluid.

37. The method of claim 34, further comprising moving a shaft, the shaft being connected to the receiver and the generator.

38. The method of claim 34, further comprising generating power during the first period of time, the power being generated including surplus power.

39. The method of claim 38, wherein the surplus power is used in the step of compressing the first fluid.
